(19) United States
(12) Patent Application Publication
(10) Pub. No.: US 2012/0059522 A1
(43) Pub. Date: Mar. 8, 2012

(54) METHOD FOR CONTROLLING THE TEMPERATURE ON COOLING MACHINES BASED ON REAL AND PREDICTED PATTERNS OF USE AND INTERNAL/EXTERNAL TEMPERATURES

(75) Inventors: Douglas Alexandre Gomes Vieira, Belo Horizonte (BR); Adriano Chaves Lisboa, Belo Horizonte (BR)

(73) Assignee: ENGENHARIA ASSISTIDA POR COMPUTADOR LTDA, Belo Horizonte (BR)

(21) Appl. No.: 12/877,107

(22) Filed: Sep. 8, 2010

(51) Int. Cl. G05D 23/00

(52) U.S. Cl. 700/278

(57) ABSTRACT

A method for controlling the on/off cycles of a refrigerator based on the real and predicted patterns of use and external temperature is disclosed. This control avoids waste of energy in situations in which the approximate instant the refrigerator will have its chamber opened/closed is known in advance. The patterns of use considers instant and duration of the events of opening/closing the chamber, and they can be set by factory, by another device such as a computer and pendrives among others, by the user or they can be learnt using computational intelligence techniques. Moreover, it also considers the real and predicted external temperature to optimize the heating exchanging. The predicted temperature can be learnt by machine learn techniques, accessed through network connection, accessed from another device such as a computer and pendrives among others.

### CROSS-REFERENCE TO RELATED APPLICATIONS

Not applicable.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not applicable.

### BACK GROUND OF THE INVENTION

1. Field of Invention

The present invention relates to a method for controlling a refrigeration unit, more particularly the refrigerator compressor, to optimize its on/off cycles based on the real and predicted patterns of use and internal/external temperatures. By refrigeration unit we mean every kind of appliance capable of cooling and/or freezing and/or having a compartment for such procedure. It is an “apparatus comprising means to cause a cooling effect by producing a change in the condition of a material, e.g. change of phase of a material or applying and releasing a stress on a material”.

The refrigerator unit will be under automatic control: “apparatus comprising means to sense an operating condition or a change of operating condition and exert a control on cooling means or on means handling cooled or to be cooled material”. This automatic control will be based on patterns of use and internal/external temperature.

The term “patterns of use” means every way of using the refrigeration unit which repeats during time. Instances of patterns of use are, but not limited to: i) the frequency of opening the refrigerator unit, ii) the duration of the aforementioned event, iii) the moment in time it takes place among others.

The automatic control also considers the knowledge of real and predicted external/internal temperatures to optimize its on/off cycles to reach some defined internal temperature.

2. Description of the related art

FIG. 1 describes a typical cooling machine which has its on/off cycles defined based on a user defined reference temperature 10, T_{REF}, which implies upper and lower temperature bounds 12, T_{MIN} and T_{MAX}. When its internal temperature 14, Tₗ, reaches T_{MAX} 20, the compressor is turned on 22, C=ON, to decrease that internal temperature. It is turned off 26, C=OFF, when the internal temperature gets to some lower bound 24.

The U.S. Pat. Nos. 5,524,447 and 6,796,133 B1 disclose methods that consider automatic adjustment 28 of the target temperatures 12, T_{MIN} and T_{MAX}, based the external temperature 16, T_{E}, as presented in FIG. 2. However, it does not have any mechanism to predict the temperature through out time, and to optimize the compressor cycles using this information.

In U.S. Pat. No. 5,483,804 it is disclosed defrosting method based on the number of opening/closing times of a door within time zones.

In U.S. Patent US 2010/0152904 A1 it is proposed a snooze feature in which the compressor of the refrigerator is turned off for a predetermined period of time in response to a user command.

### BRIEF SUMMARY OF THE INVENTION

Accordingly, the presented invention is directed to a method for controlling the refrigerator operation that substantially prevents one or more of the problems due to the limitations and disadvantages of the prior art.

An object of the present invention is to provide a method for controlling the operation of a refrigerator which considers the knowledge of real and predicted temperature. The real and predicted temperature is used to evaluate the heating exchanging efficiency during time such a way to turn on/off the compressor in the moments to take the most advantage of the external temperature.

Another object of the present invention is to provide a method for controlling the operation of a refrigerator based on the knowledge of real and predicted patterns of use. By patterns of use it is considered the date, time and duration of the event of opening/closing the chamber.

This invention provides, therefore, an optimized way of turning on and off the refrigerator compressor using the knowledge of patterns of use, and external/internal temperatures. This optimization is carried on such a way to increase the energy efficiency of the cooling machine through time.

The inventions presented in U.S. Pat. Nos. 5,524,447 and 6,796,133 B1 are based on the knowledge of the internal/external temperatures in the present moment. In a different way, the invention disclosed in this document considers the predicted temperature in future moments.

Differently to U.S. Pat. No. 5,483,804 which is interested in the defrosting method, this invention is interested in the cooling procedure and the energy spent to do it. While U.S. Patent no. US 2010/0152904 describes a manual way of turning off the compressor for a predefined period of time, the proposed invention defines an automatic strategy of doing it based on the patterns of use.

While in US 2008/0115511 a prediction system is used to estimate the food temperature and the food thermal mass adjusting the freezing routine, this invention considers a prediction system to defined temperatures and patterns of use.

Additional features and advantages of the invention will be set forth in the description which follows in conjunction with the accompanying drawings, and in part may be apparent from the description, or may be learned by practice of the invention. It is to be understood that both the foregoing summarized description and the following detailed description are exemplary and explanatory, and are intended to provide further explanation of the invention as claimed.

### BRIEF DESCRIPTION OF THE SEVERAL VIEWS OF THE DRAWING

These and/or other aspects of the invention will become apparent and more readily appreciated from the following description of embodiments, taken in conjunction with the accompanying drawings of which:

FIG. 1 shows a typical control for cooling machines based on its internal temperature;

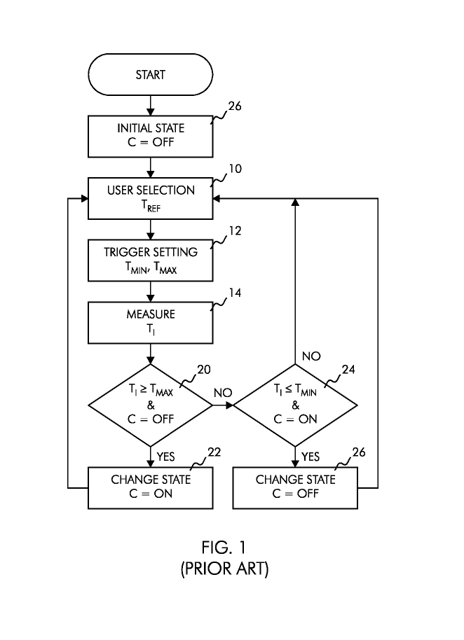

FIG. 2 shows a method that considers automatic adjustment of the triggering temperatures (T_{MIN} and T_{MAX})based the external temperature;

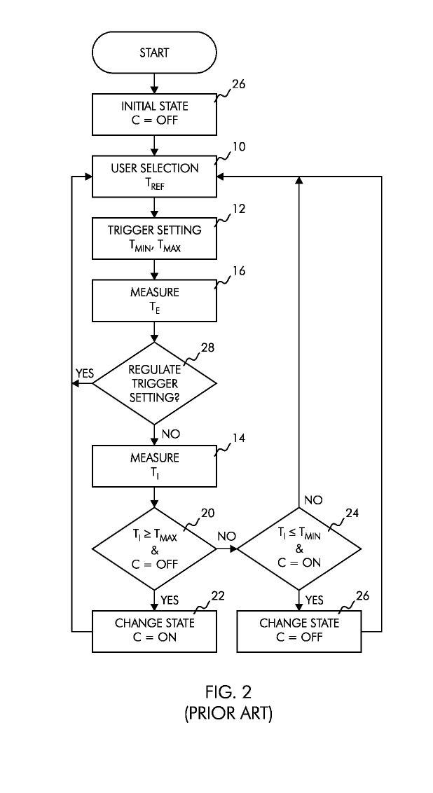

FIGS. 3A-3C show an example of a pattern of use and the refrigerator on/off cycle which does not consider the knowledge of the pattern of use;

FIGS. 4A-4C show an example of a pattern of use and the respective refrigerator optimal on/off cycle considering that the pattern of use is known;

FIG. 5 shows the refrigerator diagram according to the present invention;

FIGS. 6A-6C show an example of external temperature and internal temperature of a typical refrigerator with respective on/off cycle;

FIGS. 7A-7C show an example of external temperature and internal temperature of a refrigerator with respective optimal on/off cycle considering that the future external temperature is known.

### DETAILED DESCRIPTION OF THE INVENTION

As aforementioned, the present invention relies on the knowledge of the real and predicted patterns of use and internal/external temperatures to optimize the refrigeration cycle.

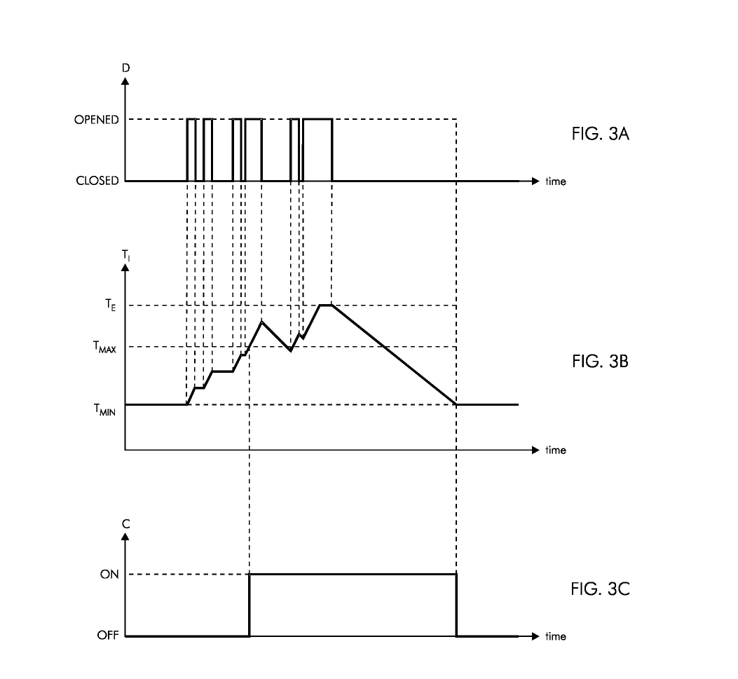

An example of a real pattern of use is presented as follows. Consider a family who has its breakfast at 6.30 a.m. every week day. In their routine, between 6.30 and 7.00 a.m. the refrigerator door is opened many times by the family members, as shown in FIG. 3A. Every time the door is opened, the refrigerator internal temperature is risen due to its heat exchange with the external environment, as show in FIG. 3B. Additionally, consider that, at 6.45 a.m, this routine makes the temperature rises over the upper bound, as shown in FIG. 3B, thus, making the compressor to be turned on, as shown in FIG. 3C. Observe that it is very likely to take place since the door will be opened many times.

After 6.45 a.m., even though the compressor is turned on, as shown in FIG. 3C, the family keeps opening the door, FIG. 3A, thus, the energy which is used to cool the chamber will be wasted, by heating exchanging with the external room, till the time 7.00 a.m., when the family stops opening the refrigerator door.

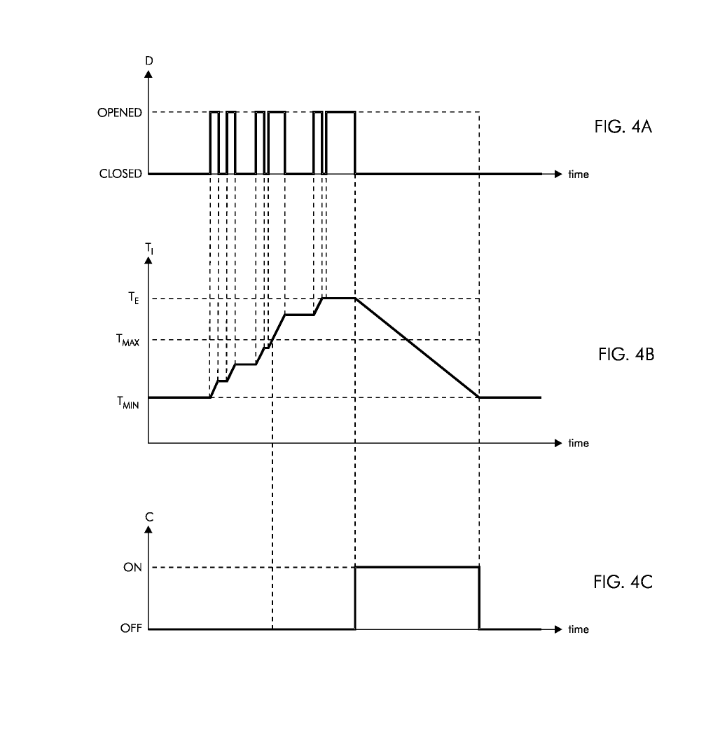

However, if the refrigerator knew this routine it could have waited till 7.00 a.m. to start cooling and, therefore, avoid energy wasting, as shown in FIGS. 4A-4C.

Moreover, since it is known that the opening routine will start at 6.30 a.m. it does not make sense that the chamber temperature to be close to the lower bound. In case it is closer to the lower bound the waste of energy due to heating exchange will be higher than if it is closer to the higher bound. However, it must also consider the amount of time the food can be exposed to the higher temperatures.

This invention considers that this routine is a pattern of use. Patterns of use can be defined from factory, settled by the user, or automatic learnt by some machine learn technique such as neural networks, support vector machines, hidden Markov model, radial basis function, parallel layer perceptron among others.

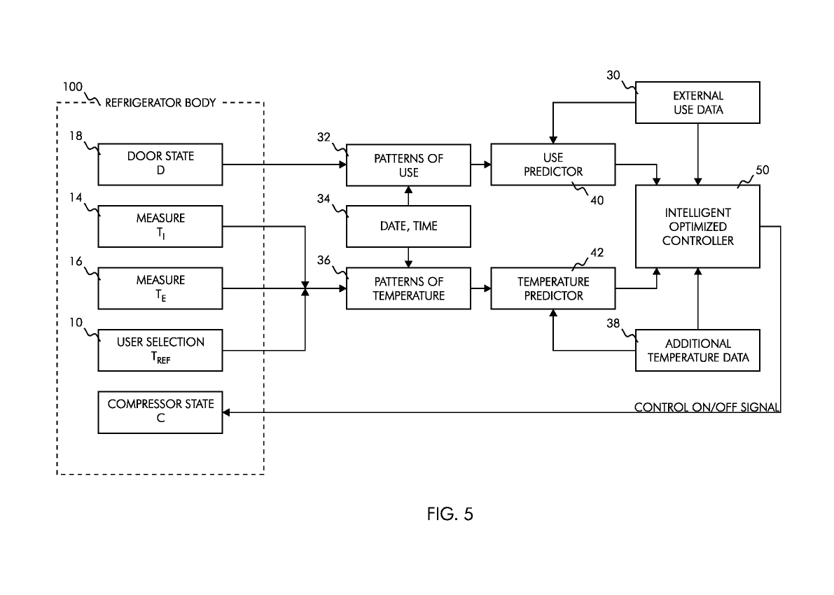

With reference to FIG. 5, the refrigerator body 100 is composed by sensor to measure the internal temperature Tₗ, unit 14, and external temperature T_{E}, unit 16. It is also composed by a mechanism to the user to select the reference temperature T_{REF}, unit 10. Additionally, it has a sensor to detect the events of opening/closing its door D, unit 18.

The simplest control rule for the presented invention takes into account some external patterns of use, unit 30. These can be set by factory, by the user, accessed using network connection among other. For instance, the user can define that the door will not be opened between 7.00 a.m and 5.30 p.m. during weekdays because he/she is out to work. The most common aspects, such as bank holidays, school breaks, seasons among others can be set from factory.

The information provided by the door sensor 18 can store in patterns of use data set, unit 32, with the date and time labels, unit 34. Thus, a predictor of patterns of use, unit 40, can be built to supply information to the intelligent optimized controller, unit 50.

A data set with the internal and external temperatures, unit 36, is also considered in the invention. This data set is accessed by a temperature predictor, unit 42, which provides information to the controller, unit 50. Additional temperature data 38, such as weather forecasting obtained by network access, can also be considered to feed 50.

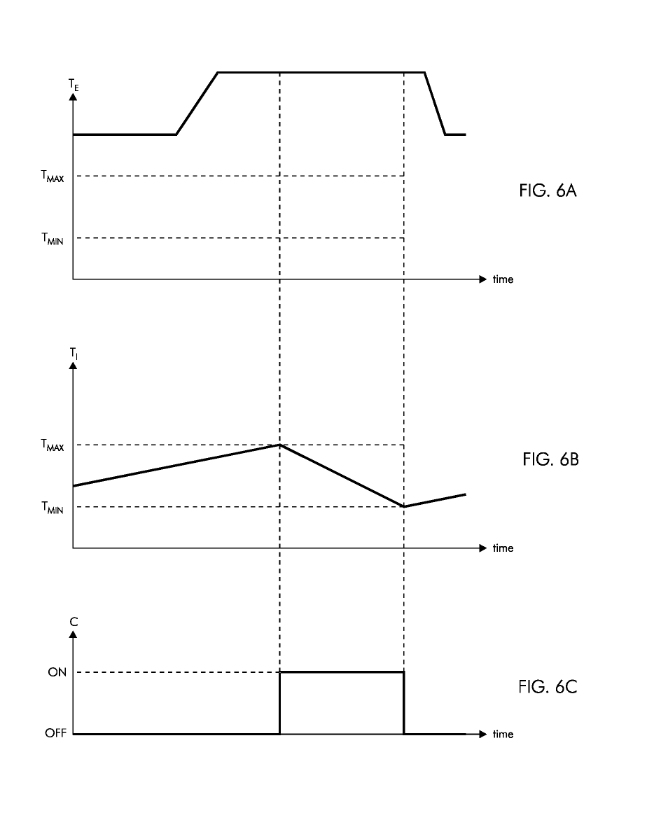

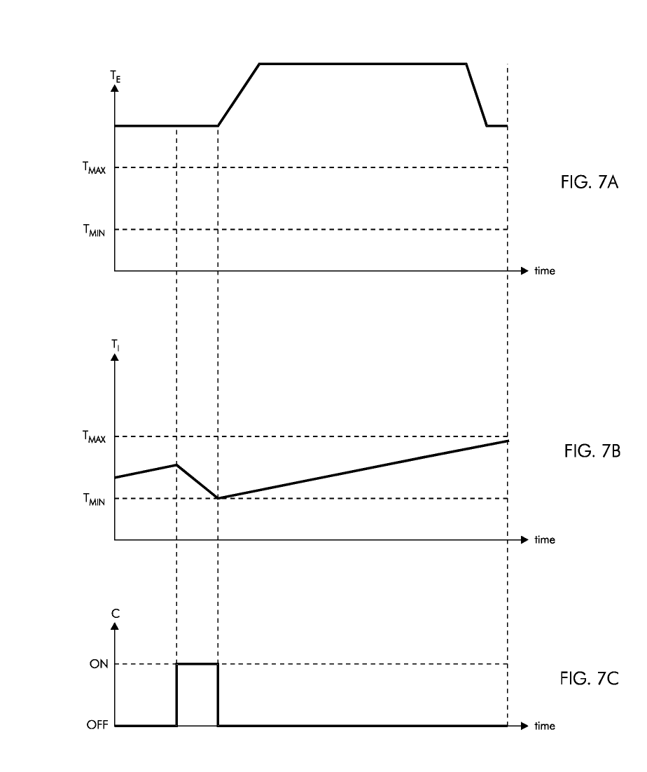

In FIG. 6A, one example of external temperature for a refrigerator operation is presented. Its internal temperature is presented in FIG. 6B. It is clear from FIGS. 6B and 6C that, when the internal temperature goes above T_{MAX} the compressor is turned on. In FIG. 7C is presented the intelligent control under the same settings. Even though the temperature has not reached yet the upper bound, as shown in FIG. 7B, the controller, unit 50, decides to take advantage of the fact the external temperature will rise abruptly in some known point in the future, as shown in FIG. 7A. In this case, it decides to turn on the compressor earlier to take advantage of lower external temperatures, and, therefore, better heating exchange. In this case, it needs to stay on for only a short period of time, as shown in FIG. 7C.

Although the present invention has been described and illustrated in detail, it is clearly understood that the same is by way of illustration and example only, and it is not to be taken by way of limitation, the spirit and scope of the present invention being limited only by terms of the appended claims.

What is claimed:

1. A method for controlling the operation of a cooling machine comprising:
i. Predefined patterns of chamber opening/closing events with date, time and duration;
ii. A sensor to measure the refrigerator internal temperature;
iii. A control signal to turn on/off the compressor based on patterns and known temperatures.

2. A method in accordance with claim 1 further comprising a sensor to measure the refrigerator external temperature.

3. A method in accordance with claim 1 further comprising external data with predicted external temperature.

4. A method in accordance with claim 2 further comprising external data with predicted external temperature.

5. A method in accordance with claim 1 further comprising:
i. A door sensor;
ii. A data set with the chamber opening/closing events from the sensor;
iii. A predictor to extract and define patterns of use from the aforesaid data set.

6. A method in accordance with claim 2 further comprising:
i. A door sensor;
ii. A data set with the chamber opening/closing events from the sensor;
iii. A predictor to extract and define patterns of use from the aforesaid data set.

7. A method in accordance with claim 3 further comprising:
i. A door sensor;
ii. A data set with the chamber opening/closing events from the sensor;
iii. A predictor to extract and define patterns of use from the aforesaid data set.

8. A method in accordance with claim 4 further comprising:
i. A door sensor;
ii. A data set with the chamber opening/closing events from the sensor;
iii. A predictor to extract and define patterns of use from the aforesaid data set.

9. A method in accordance with claim 4 further comprising:
i. A data set with the external temperature and some additional temperature data;
ii. A predictor to extract and define patterns of temperature using the aforesaid data set.

10. A method in accordance with claim 8 further comprising:
i. A data set with the external temperature and some additional temperature data;
ii. A predictor to extract and define patterns of temperature from the aforesaid data set.
